(19) United States
(12) Patent Application Publication
(10) Pub. No.: US 2026/0084220 A1
(43) Pub. Date: Mar. 26, 2026

(54) MACHINE TOOL CONTROL DEVICE AND MACHINE TOOL DISPLAY DEVICE

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 19/110,371

(22) PCT Filed: Sep. 30, 2022
(86) PCT No.: PCT/JP2022/036755

§ 371 Date: Mar. 10, 2025

(51) Int. Cl. B23B 27/14; B23G 5/00; G05B 19/18

(52) U.S. Cl. CPC B23B 27/143; B23G 5/00; G05B 19/182; G05B 2219/45215

(57) ABSTRACT

Provided is a technology capable of reliably carrying out air cutting during oscillation machining for threading regardless of oscillation phase differences. This machine tool control device 1 comprises: a condition acquisition unit 11 for acquiring, as a precondition, one or two pieces of information among three pieces of information, namely, an oscillation phase difference, information regarding a workpiece radial cut depth, and information regarding a radial oscillation amplitude of the workpiece; an air cut amount acquisition unit 12 for acquiring a specified air cut amount indicating the degree of air cut in the oscillation direction; and a machining control unit 13 for determining (a) piece(s) of information not acquired by the condition acquisition unit 11 among the three pieces of information on the basis of the precondition and carrying out machining control such that an air cut amount based on the interval between the n-th threading path and a threading path subsequent to the n-th path matches the specified air cut amount.

### TECHNICAL FIELD

The present disclosure relates to a control device for a machine tool and a display device for a machine tool.

### BACKGROUND ART

During machining, chips are continuously generated. It is known to perform machining while relatively oscillating a cutting tool and a workpiece in order to avoid a situation in which entanglement of the chips with the workpiece and the cutting tool or a similar behavior of the chips causes machining defects, machine failures, and the like.

In the oscillating machining of this type, a setting is made such that a tool path, which is a trajectory of the tool, partially overlaps with the previous tool path. As a result, the tool is caused to perform idle motion while being separate from the surface of the workpiece, which is called air cutting, whereby the chips are shredded (see for example, Patent Document 1).

### CITATION LIST

### Patent Document

Patent Document 1: Japanese Patent No. 6709163

### DISCLOSURE OF THE INVENTION

### Problems to be Solved by the Invention

Incidentally, in the oscillating machining for turning, a phase difference varies depending on a set frequency multiplying factor. On the other hand, in oscillating machining for thread cutting, a phase difference between the previous pass and the current pass can be arbitrarily determined by a control device. However, when the previous pass and the current pass do not have the same frequency, air cutting cannot be made constant and varies from pass to pass. For this reason, the oscillation phase difference is set to 180 degrees in consideration of efficiency.

In the technique described in Patent Document 1, an oscillation amplitude is set based on an amount of idle motion. However, since the technique is based on the assumption that the oscillation phase difference between the previous pass and the current pass is 180 degrees as in the known art, there is room for improvement in order that the idle motion is appropriately performed even in a case where the oscillation phase difference is not 180 degrees.

The present disclosure has been achieved in view of the above-described disadvantages, and an object of the present disclosure is to provide a technique that allows air cutting to be reliably performed regardless of an oscillation phase difference in oscillating machining for thread cutting.

### Means for Solving the Problems

The present disclosure is directed to a control device for a machine tool that performs thread cutting with a cutting tool that oscillates relative to a workpiece, the control device including: a condition acquisition unit configured to acquire, as a precondition, one or two pieces of information from among three pieces of information including an oscillation phase difference between an n-th thread cutting pass and a thread cutting pass subsequent to the n-th thread cutting pass, information regarding a cut amount in a radial direction of the workpiece, and information regarding an oscillation amplitude in the radial direction of the workpiece; an air cutting amount acquisition unit configured to acquire a designated air cutting amount that indicates a degree of air cutting in an oscillation direction; and a machining control unit configured to determine, based on the precondition, the information among the three pieces of information that is not acquired by the condition acquisition unit such that an air cutting amount based on an interval between the n-th thread cutting pass and the thread cutting pass subsequent to the n-th thread cutting pass becomes equal to the designated air cutting amount.

The present disclosure is further directed to a display device for a machine tool that performs thread cutting with a cutting tool that oscillates relative to a workpiece, the display device including: a condition input unit configured to receive, as a precondition, an input of one or two pieces of information from among three pieces of information including an oscillation phase difference between an n-th thread cutting pass and a thread cutting pass subsequent to the n-th thread cutting pass, information regarding a cut amount in a radial direction of the workpiece, and information regarding an oscillation amplitude in the radial direction of the workpiece; an air cutting amount input unit configured to receive an input of a designated air cutting amount that indicates a degree of air cutting in an oscillation direction; an information calculation unit configured to calculate, based on the precondition, the information among the three pieces of information that is not received by the condition input unit such that an air cutting amount based on an interval between the n-th thread cutting pass and the thread cutting pass subsequent to the n-th thread cutting pass becomes equal to the designated air cutting amount; and a display unit configured to display the information calculated by the information calculation unit.

### Effects of the Invention

The present disclosure provides a technique that allows air cutting to be reliably performed regardless of an oscillation phase difference in oscillating machining for thread cutting.

### BRIEF DESCRIPTION OF THE DRAWINGS

FIG. 1 is a functional block diagram of a control device for a machine tool according to an embodiment of the present invention;

FIG. 2 is a block diagram illustrating conditions acquired by a condition acquisition unit according to the embodiment;

FIG. 3 illustrates an example of a machining program;

FIG. 4 is a graph illustrating a positional relationship between a workpiece and a cutting tool; and

FIG. 5 is a functional block diagram of a display device for a machine tool according to a modification.

### PREFERRED MODE FOR CARRYING OUT THE INVENTION

The following describes embodiments of the present disclosure in detail with reference to the drawings.

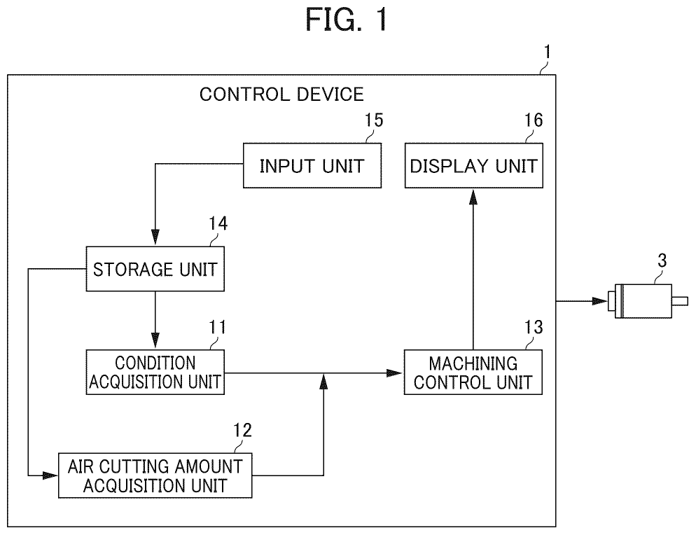

FIG. 1 is a functional block diagram of a control device 1 for a machine tool according to an embodiment of the present invention. The control device 1 for a machine tool according to the embodiment of the present invention is adapted for performing thread cutting using a cutting tool that oscillates relative to a workpiece in a radial direction. For the sake of convenience, FIG. 1 illustrates only a motor 3 that drives one feed shaft. It should be noted that, for the cutting according to the present embodiment, the workpiece is not limited to any shape. Specifically, the cutting according to the present embodiment is applicable to a case where a plurality of feed axes (a Z-axis and an X-axis) are necessary to machine a workpiece having a tapered portion or an arc-shaped portion on a surface thereof to be machined and a case where a specific single feed axis (a Z-axis) is sufficient to machine a workpiece having a circular columnar shape or a cylindrical shape.

The control device 1 for a machine tool is constituted by, for example, a computer including memories such as a read only memory (ROM) and a random access memory (RAM), a central processing unit (CPU), and a communication control unit, which are connected to each other via a bus. The functions and operations of the functional units are implemented by cooperation between the CPU and the memories incorporated in the computer and control programs stored in the memories. The control device 1 for a machine tool may be constituted by a computer numerical controller (CNC), a programmable logic controller (PLC), or the like. Alternatively, the control device 1 for a machine tool may be connected to a host computer that outputs, in addition to a machining program, machining conditions such as a rotation speed and the like.

As illustrated in FIG. 1, the control device 1 for a machine tool includes a condition acquisition unit 11, an air cutting amount acquisition unit 12, a machining control unit 13, a storage unit 14, an input unit 15, and a display unit 16.

The condition acquisition unit 11 acquires a machining condition and an oscillation condition for performing oscillating machining on the workpiece W. The machining condition and the oscillation condition may be stored in the storage unit 14, or may be outputted from an external computer.

Here, the machining condition includes at least information regarding a feed amount per relative rotation of the cutting tool and the workpiece and information regarding a shape of a cutting edge of the cutting tool. In addition, the machining condition includes, for example, information regarding a rotation number S (1/min) of a spindle, a feed rate (mm/min) for the cutting tool, a workpiece radius (mm), a clearance angle (°) of the cutting tool, and the like. Examples of the information regarding a feed amount per relative rotation of the cutting tool and the workpiece include a feed amount F per rotation (mm/rev), a combination of a rotation number S (1/min) of the spindle and a feed rate (mm/min) for the cutting tool, and the like. An example of the information regarding the shape of the cutting edge of the cutting tool is the cutting edge R (mm).

The oscillation condition includes information regarding the number of oscillations in a radial direction of the workpiece and information regarding an oscillation amplitude in the radial direction of the workpiece. An example of the information regarding the number of oscillations in the radial direction of the workpiece is an oscillation frequency multiplying factor I (times) that indicates an oscillation frequency per rotation of a spindle. An example of the information regarding the relative oscillation amplitude of the cutting tool and the workpiece in the radial direction of the workpiece is an oscillation amplitude multiplying factor K (times) that indicates the magnitude of an oscillation amplitude with respect to a cutting amount in the radial direction of the workpiece in the thread cutting.

The air cutting amount acquisition unit 12 acquires a designated air cutting amount, which is designated in advance by an operator or the like. For example, the air cutting amount may be stored in the storage unit 14, may be acquired from an external computer, or may be inputted via the input unit 15.

The air cutting amount as used herein refers to an air cutting amount in the interval between an n-th thread cutting pass and a thread cutting pass subsequent to the n-th thread cutting pass (the (n+1)-th or subsequent thread cutting pass). In the present embodiment, the air cutting amount in the interval between the n-th thread cutting pass and the (n+1)-th thread cutting pass is used to determine the machining condition. An air cutting amount in the interval between the n-th thread cutting pass and the (n+2)-th thread cutting pass may be used to determine the machining condition.

In the present embodiment, a distance in an oscillation direction is used as the air cutting amount. In the present embodiment, the oscillation takes place in the radial direction of the workpiece, and accordingly, the air cutting amount is a numerical value indicating a degree of air cutting in the radial direction of the workpiece. It is suitable that the air cutting amount is an indicator of the magnitude of the air cutting, and the air cutting amount may be a distance in the oscillation direction. Alternatively, the air cutting amount may be expressed by an area including the oscillation direction, a level associated with an air cutting amount determined in advance in a table, or a multiplying factor with respect to an arbitrary reference value (e.g., a cut amount, etc.).

The machining control unit 13 performs machining control based on the condition acquired by the condition acquisition unit 11 such that the air cutting amount after a start of machining becomes equal to the designated air cutting amount. The details of the machining control by the machining control unit 13 will be described later.

The storage unit 14 stores therein various kinds of information for controlling the machine tool and for performing machining. In the present embodiment, the storage unit 14 stores therein the machining condition, the oscillation condition, and the air cutting amount designated by the operator. The machining condition, the oscillation condition, and the air cutting amount are, for example, inputted to a machining program by the operator or designated as parameters of the machine tool. The storage unit 14 may be disposed outside the control device 1, instead of being disposed in the control device 1.

The input unit 15 inputs information regarding the machining, in response to the operator performing input operation on an input means (not shown) such as a keyboard or a touch panel. The information regarding the machining inputted by the input unit 15 is stored in the storage unit 14 and the like, or is inputted to each unit of the control device 1.

The display unit 16 displays various kinds of information regarding the machine tool, the control device 1, and the machining.

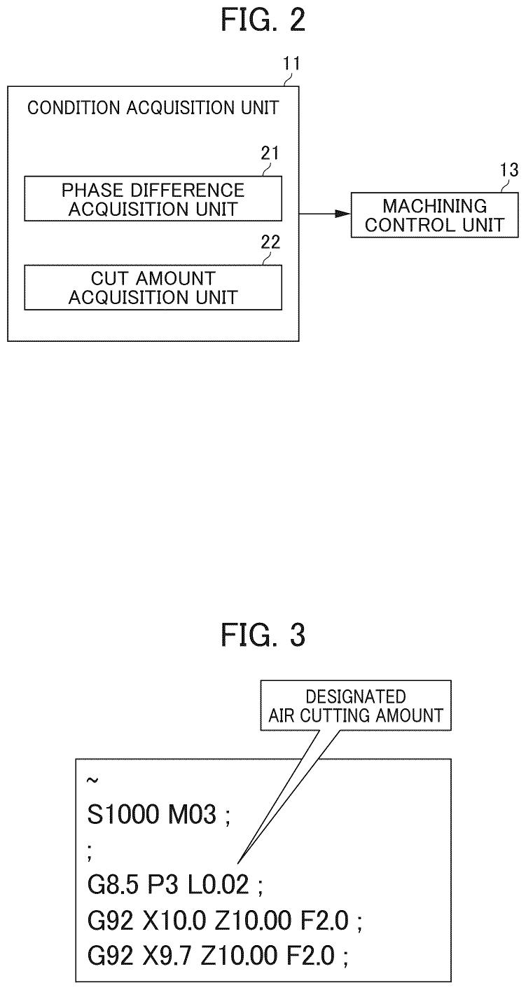

Next, the conditions acquired by the condition acquisition unit 11 and the machining control performed by the machining control unit 13 will be described with reference to FIG. 2. FIG. 2 is a block diagram illustrating the conditions acquired by the condition acquisition unit 11 of the present embodiment.

As illustrated in FIG. 2, the condition acquisition unit 11 includes a phase difference acquisition unit 21 and a cut amount acquisition unit 22. The phase difference acquisition unit 21 acquires, as a condition of the thread cutting, an oscillation phase difference set in the control device 1 for a machine tool. The cut amount acquisition unit 22 acquires a cut amount of the thread cutting as a condition of the thread cutting.

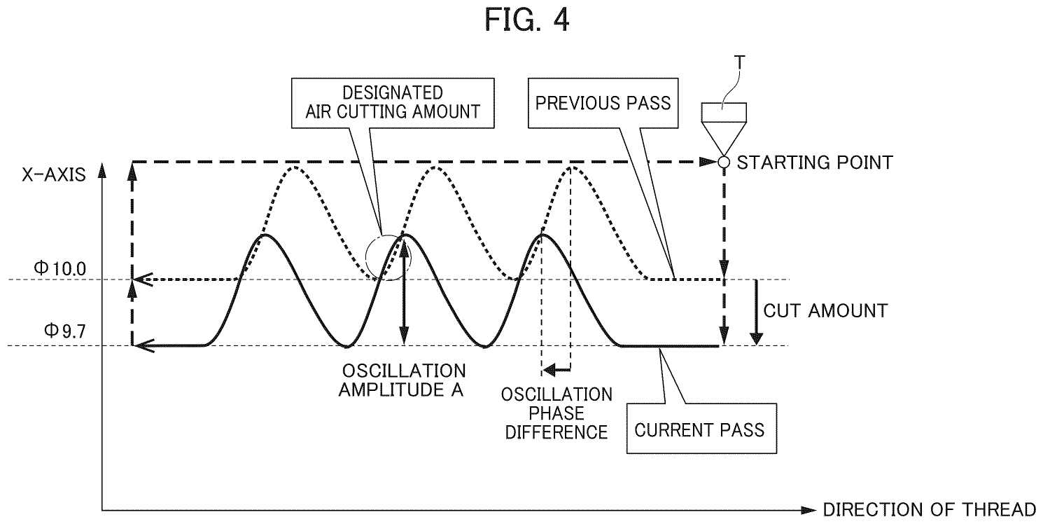

Next, an example of the control by the control device 1 of the present embodiment will be described. FIG. 4 is a graph illustrating a positional relationship between the workpiece and the cutting tool T. The machining program illustrated in FIG. 3 contains various kinds of information designated by an operator via the input unit 15 or the like.

The graph of FIG. 4 illustrates the positional relationship between the workpiece and the cutting tool T. The machining control unit 13 determines an oscillation amplitude such that the air cutting amount in the interval between the previous pass that is the n-th cutting pass and the current pass that is the (n+1)-th cutting pass becomes equal to the designated air cutting amount. The oscillation amplitude is in the same direction as the X-axis direction in which a cut is given into the workpiece.

In the machining program illustrated in FIG. 3, the block “S1000 M03” is a description indicating that the spindle is to be rotated forward. The block “G8.5 P3 L0.02” includes “L0.02” that indicates a designated air cutting amount. Based on the block “G92 X10.0 Z10.00 F2.0” and the block “G92 X9.7 Z10.00 F2.0”, a cut amount can be derived from the difference between the X coordinates.

Upon a start of machining operation, the condition acquisition unit 11 of the control device 1 acquires the oscillation phase difference held as a setting of the control device 1. In this example, a phase difference of 90 degrees is set in the control device 1. The condition acquisition unit 11 acquires an oscillation phase difference of 90 degrees.

The condition acquisition unit 11 further acquires a cut amount from the machining program. In the example illustrated in FIG. 3, a cut amount of 0.3 [mm] is derived from “X10.0” and “X9.7”, which is calculated as follows: 10.0-9.7=0.3 [mm]. The air cutting amount acquisition unit 12 acquires a designated air cutting amount. In the example illustrated in FIG. 3, the air cutting amount acquisition unit 12 acquires a designated air cut amount of 0.02 [mm] from “L0.02”.

Based on the oscillation phase difference and the cut amount, which are the conditions acquired by the condition acquisition unit 11, and based on the designated air cutting amount acquired by the air cutting amount acquisition unit 12, the machining control unit 13 determines an oscillation amplitude for performing the thread cutting in accordance with the following equation. In this example, a phase angle of 90 [° ], a cut amount of 0.3 [mm], and a designated air cut amount of 0.02 [mm] are substituted into the equation.

$$( \frac{A}{2} ) ( 1 - cos ( I ( θ - 90 ° ) ) ) - X - ( \frac{A}{2} ) ( 1 - cos ( I θ ) ) = L [ mm ] \qquad [ Eq . 1 ]$$

In Equation (1), I represents a frequency multiplying factor [times], L represents a designated air cutting amount [mm], A represents am oscillation amplitude [mm], and θ represents a workpiece phase [° ] in which the air cutting amount L is achieved.

The machining control unit 13 outputs information indicating the calculated oscillation amplitude to the display unit 16. The display unit 16 conveys the oscillation amplitude to the operator by means of character information indicating the oscillation amplitude, graphic information indicating the oscillation amplitude, a combination thereof, or the like.

According to the above-described embodiment, the control device 1 for a machine tool that performs thread cutting with a cutting tool T that oscillates relative to a workpiece exerts the following effects.

The control device 1 for a machine tool according to the present embodiment includes: a condition acquisition unit 11 that acquires, as a precondition, one or two pieces of information from among three pieces of information including an oscillation phase difference between an n-th thread cutting pass and a thread cutting pass subsequent to the n-th thread cutting pass, information regarding a cut amount in a radial direction of the workpiece, and information regarding an oscillation amplitude in the radial direction of the workpiece; an air cutting amount acquisition unit 12 that acquires a designated air cutting amount indicating a degree of air cutting in an oscillation direction; and a machining control unit 13 that determines, based on the precondition, the information among the three pieces of information that is not acquired by the condition acquisition unit 11 such that an air cutting amount based on an interval between the n-th thread cutting pass and the thread cutting pass subsequent to the n-th thread cutting pass becomes equal to the designated air cutting amount. Due to this feature, since the designated air cutting amount is set as a target, even if the machining condition is changed during the thread cutting, it is possible to accurately determine whether or not chip shredding is possible. Furthermore, a margin can be specified based on the designated air cutting amount, which makes it possible to perform an appropriate idle motion even if the oscillation phase difference is not 180 degrees.

The condition acquisition unit 11 of the present embodiment acquires, as the precondition, the oscillation phase difference and the information regarding the cut amount from among the three pieces of information, and the machining control unit 13 determines the information regarding the oscillation amplitude based on the oscillation phase difference and the information regarding the cut amount such that the air cutting amount based on the interval between the n-th thread cutting pass and the thread cutting pass subsequent to the n-th thread cutting pass becomes equal to the designated air cutting amount. This feature makes is possible to accurately calculate an oscillation amplitude corresponding to the designated air cutting amount even if the oscillation phase difference is not 180 degrees.

The control device 1 of the present embodiment further includes a display unit 16 that outputs the information determined by the machining control unit 13. This feature allows an operator to easily check safety and a manufacture plan, based on the calculation result from the machining control unit 13 such as the oscillation amplitude.

In the above embodiment, the machining control unit 13 calculates the oscillation amplitude, but the machining control unit 13 may be configured to determine an amplitude multiplying factor instead of the oscillation amplitude. In this case, at a control stage, an amplitude is determined from a cut amount in the radial direction of the workpiece in the thread cutting and the amplitude multiplying factor, and the control is performed based on the amplitude.

The machining control unit may be configured to determine information different from the information regarding the oscillation amplitude, depending on the condition acquired by the condition acquisition unit. For example, the condition acquisition unit may acquire the oscillation phase difference and the information regarding the oscillation amplitude, and the machining control unit may determine the information regarding the cut amount based on the oscillation phase difference and the information regarding the oscillation amplitude. Alternatively, the condition acquisition unit may acquire the oscillation phase difference and identification information for identifying the information regarding the cut amount and the information regarding the oscillation amplitude, and the machining control unit may determine the information regarding the cut amount and the information regarding the oscillation amplitude based on the oscillation phase difference and the identification information. Alternatively, the condition acquisition unit may acquire the information regarding the oscillation amplitude and identification information for identifying the information regarding the cut amount and the oscillation phase difference, and the machining control unit may determine the information regarding the cut amount and the oscillation phase difference based on the information regarding the oscillation amplitude and the identification information. Specific numerical values may be calculated according to Equation (1), for example.

Examples of the identification information include a designated upper limit value of an oscillation amplitude, a designated velocity upper limit value, a designated acceleration upper limit value, and a designated jerk upper limit value. From these upper limit values and an oscillation frequency, an oscillation amplitude can be uniquely identified. Alternatively, the identification information may be a recommended value for the oscillation phase difference, and a setting may be made such that operation is carried out at the recommended value, whereby the oscillation phase difference can be uniquely determined. Alternatively, the identification information may be an upper limit value of the cut amount in the radial direction of the workpiece and the cut amount in the radial direction of the workpiece may always be set to the upper limit value, whereby the cut amount in the radial direction of the workpiece can be uniquely identified. Furthermore, two or more of the above-described examples of the identification information may be combined. As described above, the identification information is a rule set for the machine tool, and may be any information as long as it allows the machining control unit 13 to identify the information.

The determination method and calculation method described above are examples, and information necessary for machining control may be calculated by a method different from the method using the above-described mathematical equation.

It should be noted that the present disclosure is not limited to the above-described embodiments, and modifications and improvements within a range in which the object of the present disclosure can be achieved are encompassed in the present disclosure.

In the above embodiments, the present disclosure is applied to the control device for a machine tool, but the present disclosure is not limited thereto. The present disclosure may be applied to a display device for a machine tool.

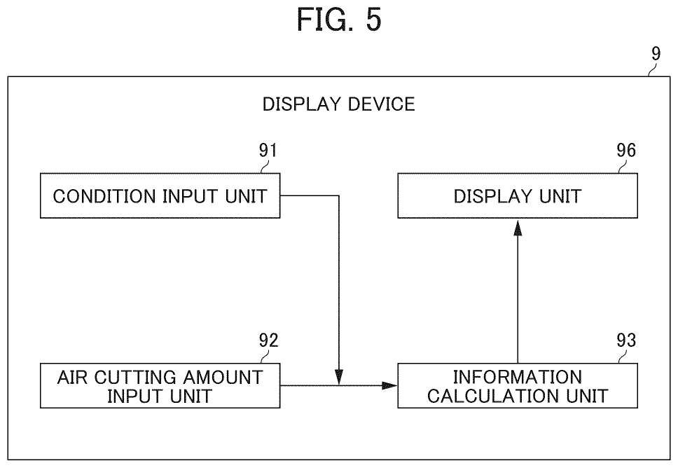

Here, FIG. 5 is a functional block diagram of a display device 9 for a machine tool according to a modification. As illustrated in FIG. 5, the display device 9 for a machine tool includes a condition input unit 91, an air cutting amount input unit 92, an information calculation unit 93, and a display unit 96.

The condition input unit 91 corresponds to the condition acquisition unit 11 of the above-described embodiment. Specifically, the condition input unit 91 receives, as a precondition, an input of one or two pieces of information from among three pieces of information including an oscillation phase difference between an n-th thread cutting pass and a thread cutting pass subsequent to the n-th thread cutting pass, information regarding a cut amount in a radial direction of a workpiece, and information regarding an oscillation amplitude in the radial direction of the workpiece.

The air cutting amount input unit 92 corresponds to the air cutting amount acquisition unit 12 of the above embodiments. Specifically, the air cutting amount input unit 92 receives an input of a designated air cutting amount that indicates a degree of air cutting in an oscillation direction.

The information calculation unit 93 corresponds to a part of the machining control unit 13. Specifically, the information calculation unit 93 calculates, based on the precondition, the information among the three pieces of information that is not received by the condition input unit, such that an air cutting amount based on an interval between the n-th thread cutting pass and the thread cutting pass subsequent to the n-th thread cutting pass becomes equal to the designated air cutting amount.

The display unit 96 corresponds to the display unit 16 of the above-described embodiments. Specifically, the display unit 96 displays the information calculated by the information calculation unit 93.

The display device 9 for a machine tool having the above-described configuration exerts the same effects as those of the control device 1 for machine tool according to the above-described embodiments.

### EXPLANATION OF REFERENCE NUMERALS

1: Control device for machine tool
11: Condition acquisition unit
12: Air cutting amount acquisition unit
13: Machining control unit
16: Display unit

1. A control device for a machine tool that performs thread cutting with a cutting tool that oscillates relative to a workpiece, the control device comprising:
a condition acquisition unit configured to acquire, as a precondition, one or two pieces of information from among three pieces of information including an oscillation phase difference between an n-th thread cutting pass and a thread cutting pass subsequent to the n-th thread cutting pass, information regarding a cut amount in a radial direction of the workpiece, and information regarding an oscillation amplitude in the radial direction of the workpiece;
an air cutting amount acquisition unit configured to acquire a designated air cutting amount that indicates a degree of air cutting in an oscillation direction; and
a machining control unit configured to determine, based on the precondition, the information among the three pieces of information that is not acquired by the condition acquisition unit such that an air cutting amount based on an interval between the n-th thread cutting pass and the thread cutting pass subsequent to the n-th thread cutting pass becomes equal to the designated air cutting amount.

2. The control device according to claim 1, wherein
the condition acquisition unit acquires, as the precondition, the oscillation phase difference and the information regarding the cut amount from among the three pieces of information, and
the machining control unit determines the information regarding the oscillation amplitude based on the oscillation phase difference and the information regarding the cut amount such that the air cutting amount based on the interval between the n-th thread cutting pass and the thread cutting pass subsequent to the n-th thread cutting pass becomes equal to the designated air cutting amount.

3. The control device according to claim 1, further comprising:
a display unit configured to output the information determined by the machining control unit.

4. A display device for a machine tool that performs thread cutting with a cutting tool that oscillates relative to a workpiece, the display device comprising:
a condition input unit configured to receive, as a precondition, an input of one or two pieces of information from among three pieces of information including an oscillation phase difference between an n-th thread cutting pass and a thread cutting pass subsequent to the n-th thread cutting pass, information regarding a cut amount in a radial direction of the workpiece, and information regarding an oscillation amplitude in the radial direction of the workpiece;
an air cutting amount input unit configured to receive an input of a designated air cutting amount that indicates a degree of air cutting in an oscillation direction;
an information calculation unit configured to calculate, based on the precondition, the information among the three pieces of information that is not received by the condition input unit such that an air cutting amount based on an interval between the n-th thread cutting pass and the thread cutting pass subsequent to the n-th thread cutting pass becomes equal to the designated air cutting amount; and
a display unit configured to display the information calculated by the information calculation unit.

5. The control device according to claim 2, further comprising:
a display unit configured to output the information determined by the machining control unit.
